(19) United States
(12) Patent Application Publication
(10) Pub. No.: US 2021/0245263 A1
(43) Pub. Date: Aug. 12, 2021

(54) ROTARY CUTTING TOOL AND CARTRIDGE

(71) Applicant: Decatur Diamond LLC, Decatur, IN (US)

(72) Inventor: Kirk Bennett, Tipp City, OH (US)

(21) Appl. No.: 17/172,664

(22) Filed: Feb. 10, 2021

Related U.S. Application Data
(60) Provisional application No. 62/972,454, filed on Feb. 10, 2020.

(51) Int. Cl. B23B 27/16

(52) U.S. Cl. CPC B23B 27/1614

(57) ABSTRACT

A rotary cutting tool is provided that includes a cutter body, and a plurality of cartridges, fasteners, and cartridge axial adjustment mechanisms. The cutter body has a rotational axis, a circumferential exterior surface, and a plurality of cartridge pockets disposed in the circumferential exterior surface. A cartridge fastener threaded aperture is disposed in each cartridge pocket. The cartridge fastener threaded apertures extend along an axis disposed at an acute angle. Each cartridge has a body having at least one cartridge fastener aperture disposed at the acute angle. Each cartridge axial adjustment mechanism is aligned with a cartridge. Each fastener holds a cartridge against a cartridge pocket, and biases the cartridge against the aligned cartridge axial adjustment mechanism.

This application claims priority to U.S. patent application Ser. No. 62/972,454 filed Feb. 10, 2020, which application is hereby incorporated by reference in its entirety.

### BACKGROUND OF THE INVENTION

### 1. Technical Field

The present invention relates generally to a rotary cutting tools in general, and to rotary cutting tools having a rotational cutter body with a plurality of cutting tool cartridges coupled thereto.

### 2. Background Information

Conventional rotary cutting tools include an annular cutter body having a plurality of cutting tool cartridges, each received within a respective circumferentially spaced recess known as a “pocket” formed in the cutter body. The pockets and the cartridges typically have mating configurations, such that each pocket is configured to receive a cutting tool cartridge therein, and each cutting tool cartridge is configured to be seated within a pocket. Typically, each rotary cutting tool cartridge is secured in a respective pocket by means of a clamping screw, which screw extends through a hole in the cartridge and is perpendicular to the rotational axis of the rotary cutting tool. U.S. Pat. Nos. 9,266,174 and 9,868,163 describe examples of such rotary cutting tools and cartridges, and are each incorporated by reference in its entirety herein.

Each cartridge disposed with a rotary cutting tool must be positionally fixed during use of the rotary cutting tool. If a cartridge moves relative to the cutter body during operation of the rotary cutting tool, the cutting edge of the cartridge also moves relative to the cutter body. Even very small cutting edge movements are significant when the rotary cutting tool is a high precision device. In many instances, prior art rotary cutting tools rely on friction to maintain the cartridge position. The potential for a cartridge to move relative to the cutter body during operation of the tool, particularly those cartridges held by friction, often increases over time. This is especially true when the rotary cutting tool is run near or at its operational limits; e.g., at greater depths of cut, at greater rotational speeds, etc. Hence, a rotary cutting tool cartridge that is adequately fixed to a cutter body pocket during normal operating parameters, may not be adequately fixed to a cutter body pocket when the rotary cutting tool is run near or at its operational limits. In fact if a rotary cutting tool is run hard enough, it can cause a cartridge to bend or otherwise become distorted.

What is needed is a rotary cutting tool and cartridges that fix the cartridges within cutter body pockets in a manner that decreases the potential for cartridge movement, one that fixes the cartridge positions under normal operational modes and under heavy operational modes, one that facilitates cartridge positioning, and one having cartridges that are less susceptible to distortion as a result of use.

### SUMMARY

According to an aspect of the present disclosure, a rotary cutting tool is provided that includes a cutter body, a plurality of cartridges, a plurality of fasteners, and a plurality of cartridge axial adjustment mechanisms. The cutter body has a rotational axis that extends axially between a shank end and a cutter end, a circumferential exterior surface, and a plurality of cartridge pockets disposed in the circumferential exterior surface. At least one cartridge fastener threaded aperture is disposed in the cutter body in each cartridge pocket, the cartridge fastener threaded aperture extending along an axis disposed at an acute angle, the acute angle being an included angle between a radial line perpendicular to the rotational axis and the rotational axis of the cartridge fastener threaded aperture. Each cartridge has a body configured to be received within a cartridge pocket, the body having at least one cartridge fastener aperture having an axis disposed at the acute angle. Each fastener extends through the cartridge fastener aperture of a respective cartridge, and is in threaded engagement with a one of the cartridge fastener threaded apertures disposed in the cutter body. Each cartridge axial adjustment mechanism is aligned with a respective one of the plurality of cartridges. Each fastener holds a respective one of the cartridges against a respective one of the cartridge pockets, and biases the respective one of the cartridges against a respective one of the cartridge axial adjustment mechanisms.

In any of the aspects or embodiments described above and herein, the acute angle is in the range of five to forty-five degrees.

In any of the aspects or embodiments described above and herein, the acute angle may be about ten degrees.

In any of the aspects or embodiments described above and herein, each cartridge axial adjustment mechanism may include a set screw and an engagement nut, wherein each fastener biases a respective cartridge against the engagement nut of the respective cartridge axial adjustment mechanism.

In any of the aspects or embodiments described above and herein, the cartridge pockets may extend between the cutter end of the cutter body and an annular channel, and the cutter body may include a plurality of set screw threaded apertures configured for threaded engagement with the set screws. The threaded apertures may be open to the annular channel. The engagement nuts are disposed in the annular channel and each set screw is in threaded engagement with one of the set screw threaded apertures.

In any of the aspects or embodiments described above and herein, the cartridge pockets and the cartridges may have mating geometries.

In any of the aspects or embodiments described above and herein, each cartridge pocket may have converging side walls configured in a V-shape, and each cartridge has a body geometry that mates with the cartridge pocket.

In any of the aspects or embodiments described above and herein, each cartridge may include a cutting insert attached to the respective cartridge body.

According to another aspect of the present disclosure, a rotary cutting tool cartridge is provided that includes a body that extends axially between a forward end and an aft end, and has a front side and a back side. The back side is defined by a first back surface and a second back surface that extend axially between the forward end and the aft end, and converge toward one another and intersect a back edge. The body includes at least one fastener aperture that extends through the body from the front side to the back side along a fastener aperture axis that is disposed at an acute angle. The acute angle is an included angle disposed between the fastener aperture axis and a line extending perpendicular to an axial line of the cartridge. The body includes a cutting head portion disposed adjacent the forward end.

In any of the aspects or embodiments described above and herein, the acute angle is in the range of five to forty-five degrees.

In any of the aspects or embodiments described above and herein, the acute angle may be about ten degrees.

In any of the aspects or embodiments described above and herein, the back edge may be parallel to the line extending perpendicular to the axial line of the cartridge.

In any of the aspects or embodiments described above and herein, at the back edge the fastener aperture axis may be disposed a first distance from the aft end of the body, and at the front side of the body the fastener aperture axis may be disposed a second distance from the aft end of the body, and the second distance is greater than the first distance.

In any of the aspects or embodiments described above and herein, the fastener aperture may be elongated in the axial direction.

In any of the aspects or embodiments described above and herein, the cartridge may include a cutting insert attached to the body.

In any of the aspects or embodiments described above and herein, the body may include a fastener engagement surface disposed on the front side. The fastener engagement surface extends radially out from the fastener aperture in a plane perpendicular to the fastener aperture axis.

In any of the aspects or embodiments described above and herein, the body may include a support rib disposed on the front side. The support rib extends from the cutting head portion to the aft end of the cartridge.

In any of the aspects or embodiments described above and herein, a portion of the support rib may surround at least a portion of the fastener engagement surface.

In any of the aspects or embodiments described above and herein, the support rib may have a first width adjacent the aft end and a second width adjacent the cutting head portion, wherein the second width is greater than the first width.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

FIG. 1 is a perspective view of a rotary cutting tool embodiment.

FIG. 2 is a perspective view of a rotary cutting tool embodiment, with a single cartridge omitted.

FIG. 3 is an exploded view of a rotary cutting tool embodiment.

FIG. 4 is a front planar view of a cutter body of a rotary cutting tool embodiment.

FIG. 5 is a sectional view of the cutter body embodiment shown in FIG. 4 taken along cut line 5-5.

FIG. 6 is a diagrammatic side sectional view of a rotary cutting tool embodiment.

FIG. 7 is an enlarged portion of the diagrammatic side sectional view shown in FIG. 2.

FIG. 8 is a perspective view of a cartridge embodiment.

FIG. 9 is a front side view of the cartridge shown in FIG. 8.

FIG. 10 is a sectional view cut along line 10-10 shown in FIG. 9.

### DETAILED DESCRIPTION OF THE INVENTION

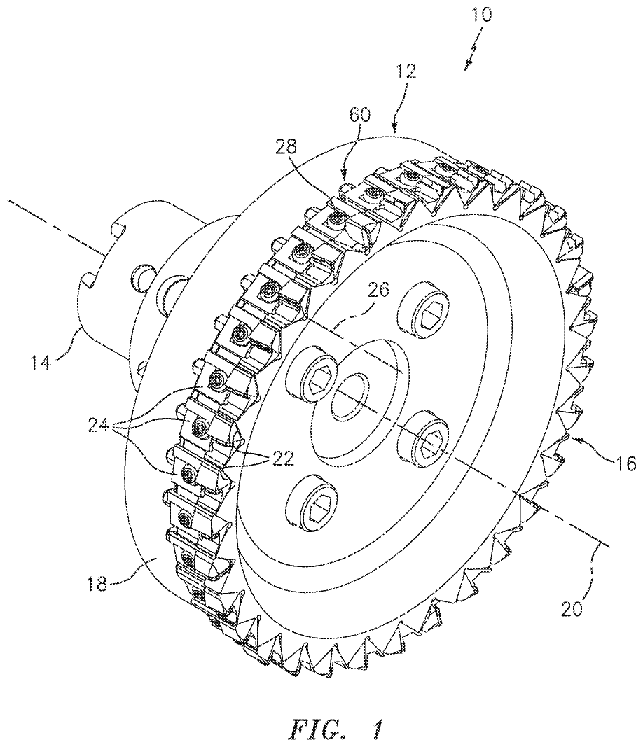

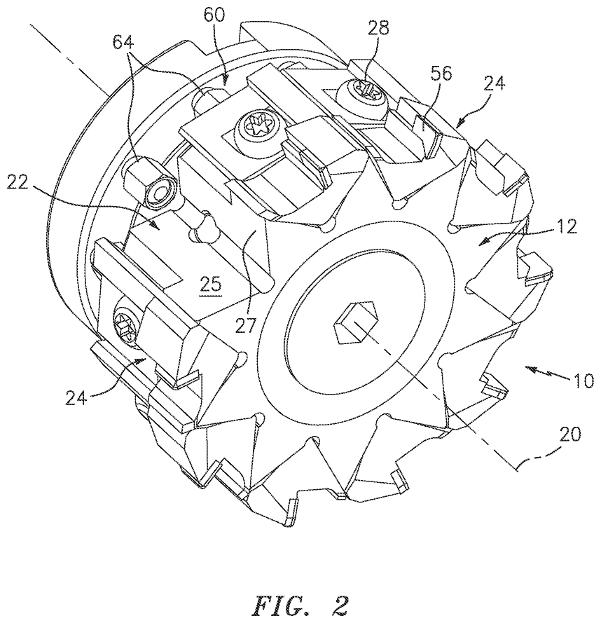

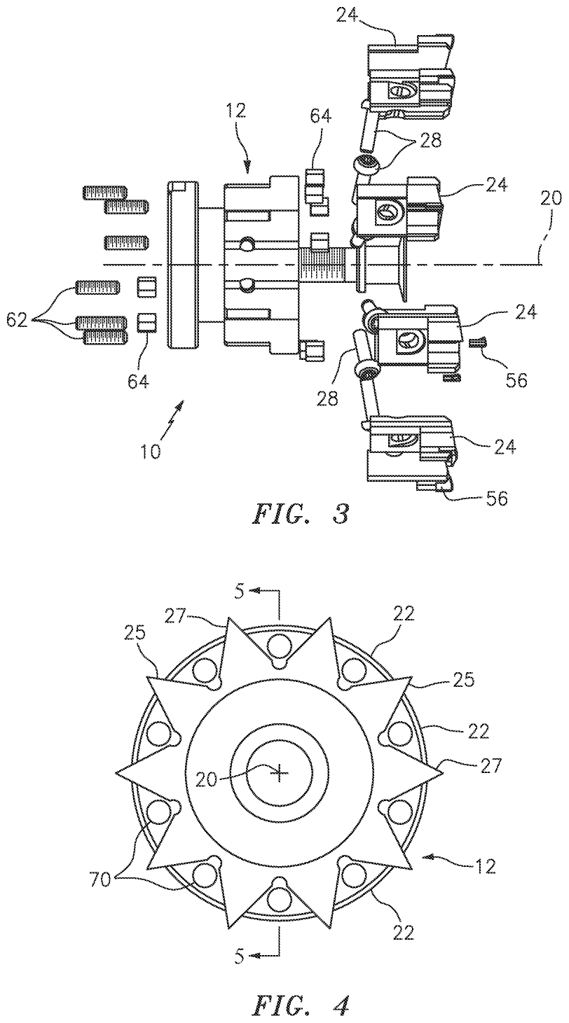

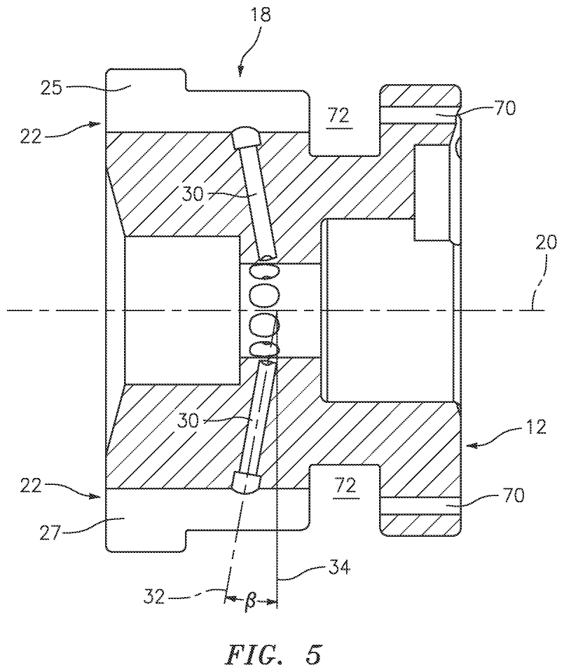

FIG. 1 is a perspective view of a rotary cutting tool 10 embodiment that includes an annular cutter body 12 and a plurality of cartridges 24 removably attached to the cutter body 12. FIG. 2 is a perspective view of a second rotary cutting tool 10 embodiment. The rotary cutting tool 10 is configured for rotation about an axially extending rotational axis 20. The cutter body 12 includes a shank end 14 and a cutter end 16 disposed at opposite axial ends. FIG. 3 is an exploded view of a rotary cutter tool 10. FIG. 4 front planar view of a cutter body. FIG. 5 is a sectional view of the cutter body shown in FIG. 4, sectioned along line 5-5. The cutter body 12 has a plurality of cartridge pockets 22 disposed in a circumferential exterior surface 18 proximate the cutter end 16 of the cutter body 12. The cartridge pockets 22 are spaced around the circumferential exterior surface 18 of the cutter body 12. The disclosure is not limited to any particular number of pockets 22, or any particular circumferential spacing of those pockets 22; e.g., the cutter body assembly shown in FIG. 1 has thirty-two (32) pockets, and the cutter body assembly shown in FIGS. 2 and 4 has ten (10) pockets. In the cutter bodies 12 shown in the Figures, the cartridge pockets 22 are uniformly spaced around the circumference of the cutter body 12. Each cartridge pocket 22 is configured to receive a cartridge 24 therein, and has a longitudinal axis 26 (e.g., see FIG. 2) that extends axially substantially parallel with the rotational axis 20 of the cutter body 12; i.e., the cartridge pockets 22 extend axially. Each pocket 22 is generally V-shaped, having side walls 25, 27 angled (i.e., converging/diverging) relative to one another. As will be described below, the cartridge pockets 22 and the cartridges have mating geometries.

As will be described below, each cartridge 24 is secured within a respective pocket by a fastener 28 that engages with a threaded fastener aperture 30 disposed within the cutter body 12; i.e., each cartridge pocket 22 includes at least one threaded fastener aperture 30. The threaded fastener apertures 30 (and the fasteners 28 when the rotary cutting tool 10 is assembled) are disposed at an acute angle “β” that extends between the axis 32 of the threaded aperture 30, and a line 34 perpendicular to the rotational axis 20 of the tool 10; i.e., a radial line. The sectional plane shown in FIG. 5 passes through the rotational axis 20 of the cutter body 12 and dissects the cartridge pocket 22. When the rotary cutting tool 10 is assembled, the cartridge fastener 28 extends within that plane and is disposed at the acute angle “β” between the axis 32 of the threaded fastener aperture 30 and the radial line 34 perpendicular to the rotational axis 20. The acute angle “β” is within the range of five to forty-five degrees (5-45°), and typically about ten degrees (˜10°). FIGS. 5, 6, 7, and 10 show an acute angle “β” of about ten degrees (−10°). The significance of the fastener 28/threaded fastener aperture 30 axis 32 relative to the forces (e.g., F_{R}, F_{A}) applied to the cartridge 24 is described below.

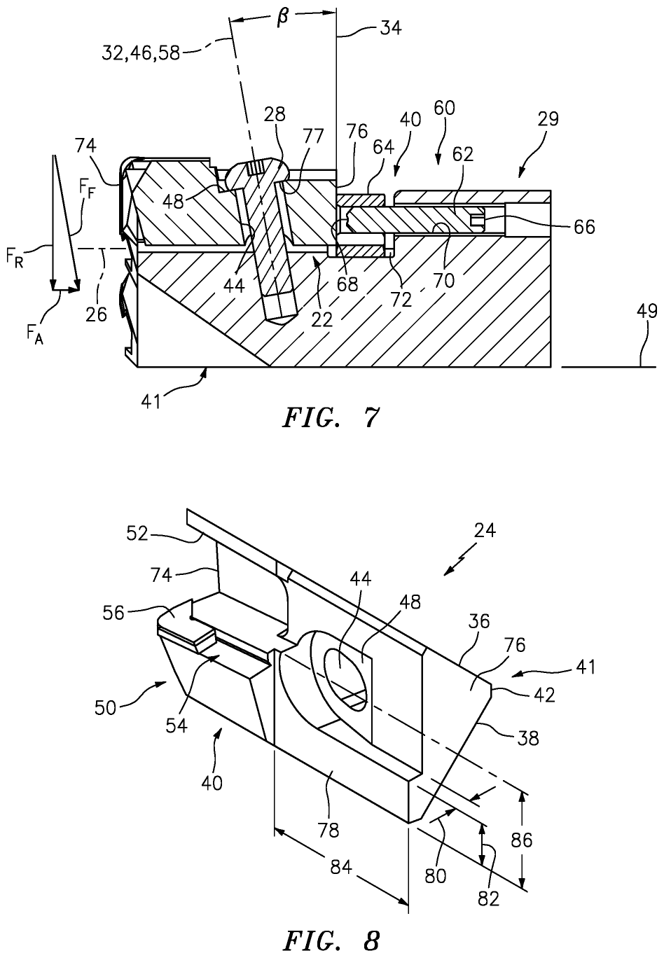

The rotary cutting tool 10 includes a cartridge axial adjustment mechanism 60. In the rotary cutting tool 10 embodiments shown in FIGS. 1-3, 6, and 7, a non-limiting example of a cartridge axial adjustment mechanism 60 is shown that includes a set screw 62 and engagement nut 64 pair aligned with each cartridge 24. The set screw 62 extends in an axial direction; e.g., parallel to the rotational axis 20 of the cutter body 12. The set screw 62 has a drive end 66 and a distal end 68 at opposite axial ends of the screw 62. The drive end 66 is configured to be engageable with a drive tool (e.g., an Allen wrench, screw driver, etc.) Each set screw 62 is configured for threaded engagement with an axially extending threaded bore 70 disposed in the cutter body 12. The cutter body 12 includes an annular channel 72 disposed in the circumferential exterior surface 18 contiguous with the pockets 22. In assembled form, each engagement nut 64 is disposed within the annular channel 72 and the distal end 68 of the respective set screw 62 is received within, and may be in threaded engagement with, the engagement nut 64. When the rotary cutting tool 10 is assembled, the engagement nut 64 is in contact with the aft end 76 of the respective cartridge 24 (e.g., see FIG. 7). The axial position of the cartridge 24 is defined by the position of the engagement nut 64, and the position of the engagement nut 64 is adjustable by rotating the set screw 62 relative to the nut 64. Rotation of the set screw 62 in a first rotational direction moves the engagement nut 64 in a first axial direction, and rotation of the set screw 62 in the opposite rotational direction moves the engagement nut 64 in a second axial direction opposite the first axial direction. Hence, the engagement nut 64, and therefore the respective cartridge 24, can be located in a plurality of different axial positions.

A cartridge axial adjustment mechanism 60, such as the example embodiment described above, enables an operator to establish positional continuity between all of the cartridges 24 disposed around the circumference of the cutter body 12. The described cartridge axial adjustment mechanism 60 is an example of a cartridge axial adjustment mechanism, and the present disclosure is not limited to this example.

Referring to FIG. 8, each cartridge 24 has a body 29 that extends axially between a forward end 74 and an aft end 76. The cartridge body 29 includes a front side 40 and a back side 41. The back side 41 includes a first back surface 36 and a second back surface 38. The first and second back surfaces 36, 38 extend axially between the forward end 74 and the aft end 76, converge toward one another, and intersect each other along a back edge 42. The first and second back surfaces 36, 38 and the front side 40 form a generally triangular cross-sectional shape. The first and second back surfaces 36, 38 of each cartridge 24 are configured to mate with the V-shaped pockets 22 disposed within the cutter body 12. In assembled form, the first and second back surfaces 36, 38 of each cartridge are in contact with the side walls 25, 27 of the respective cartridge pocket 22. The cartridge 24 includes a cutting head portion 50 disposed adjacent the forward end 74.

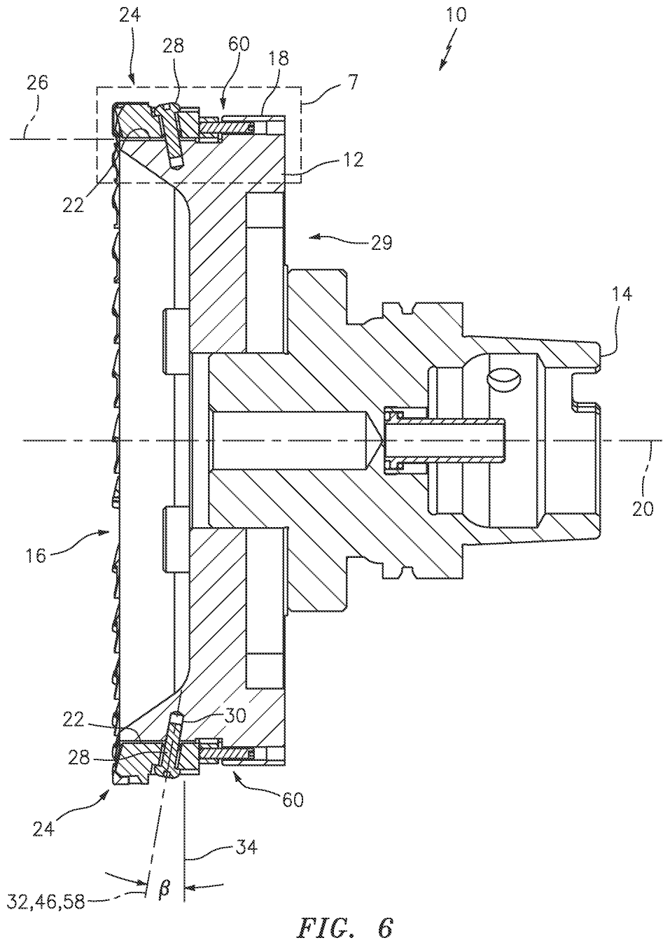

Each cartridge 24 includes at least one fastener aperture 44 having an axis 46 that extends through the cartridge 24 body from the front side 40 of the cartridge 24 to the back side 41 of the cartridge 24. The fastener aperture 44 extends through the back edge 42 of the cartridge. The fastener aperture axis 46 is disposed at the angle “β”; e.g., in terms of the cartridge 24, the angle “β” is the acute included angle disposed between the fastener aperture axis 46 and a line 47 extending perpendicular to an axial line 49 of the cartridge 24; e.g., an axial line 49 extending along the back edge 42 of the cartridge 24. The distance (L1) between the fastener aperture axis 46 and the aft end 76 of the cartridge body, taken at the back edge 42 of the cartridge 24 is less than the distance (L2) between the fastener aperture axis 46 at the front side 40 of the cartridge body 29. When the cartridge 24 is assembled with the cutter body 12, the fastener aperture axis 46 of the cartridge 24 is parallel to the respective axis 32 of the threaded aperture 30 disposed in the cutter body 12; i.e., the fastener aperture axis 46 of the cartridge 24 and the threaded fastener aperture axis 32 are disposed within the sectional plane shown in FIG. 6 that passes through the rotational axis 20 of the cutter body 12 and dissects the cartridge pocket 22 and the cartridge 24. In some embodiments, the fastener aperture 44 may be elongated in the axial direction (e.g., an oval configuration) to permit axial movement of the cartridge 24 relative to cutter body 12.

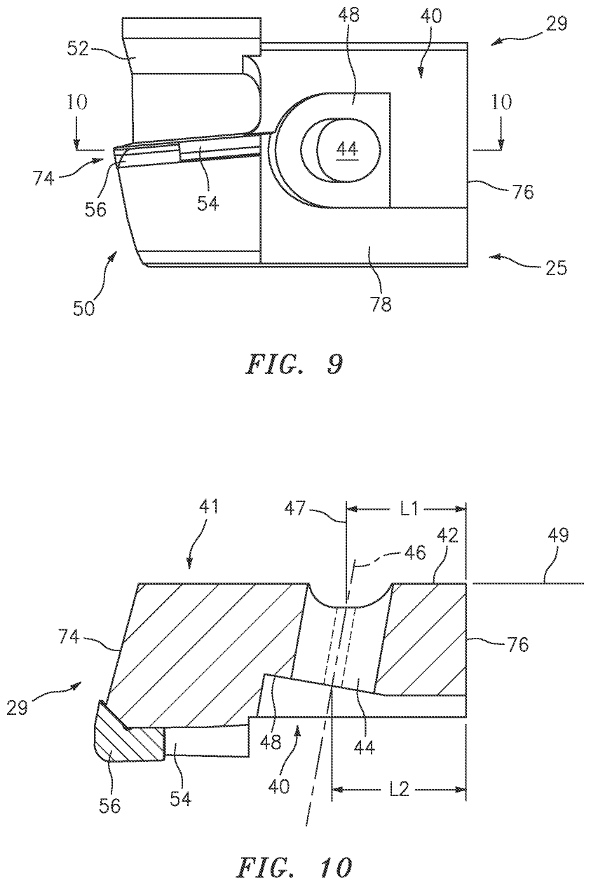

In some embodiments (e.g., see embodiments shown in FIGS. 8-10), the front side 40 of the cartridge 24 includes a fastener engagement surface 48 that extends in a plane perpendicular to the fastener aperture axis 46. A fastener 28 used to secure a cartridge 24 typically may have a head with an engagement surface 77 that extends radially outwardly from the rotational axis of the fastener 28, perpendicular to the rotational axis of the fastener 28. The fastener engagement surface 48 therefore is configured to engage the engagement surface 77 of the fastener 28. The present disclosure is not, however, limited to the above described mating perpendicular and planar engagement surfaces 48, 77; e.g., the mating engagement surfaces may be conical, etc.

In the cartridge embodiment shown in FIGS. 8-10, the front side 40 of the cartridge 24 includes a support rib 78 that extends from the cutting head portion to the aft end 76 of the cartridge 24. The support rib has a height 80, a width 82, and an axial length 84. In the embodiment shown in FIGS. 8-10, the height 80 and width 82 of the support rib 78 are substantially constant within a first portion of the support rib 78. A second portion of the support rib 78 adjacent the cutting head portion 50 has a second width 86 that is greater than the width 82 of the first portion. At least a portion of the support rib 78 is adjacent the fastener aperture 44. In some embodiments, a portion of the support rib 78 surrounds the fastener aperture 44; e.g., surrounds at least a portion of the fastener engagement surface 48. The support rib 78 is configured to increase the rigidity of the cartridge 24, and thereby decrease the possibility of deflection (e.g., elastic axial defection or deflection that may result in axial plastic deformation). Any axial defection of the cartridge 24 can result in an undesirable displacement of cutting insert 56. The support rib 78 embodiment shown in FIG. 8 is an example of a support rib that may be included in a present disclosure cartridge 24, and the present disclosure is not limited to thereto.

As described above if a rotary cutting tool 10 is run hard enough (e.g., operated at a large depth of cut, a high tool feed rate, a high rotational velocity, or any combination thereof, etc.) to expose a cartridge 24 to significant forces, a cartridge may axially bend (e.g., the body may plastically deform and no longer extends axially along a straight line) or otherwise become distorted. If a cartridge does axially deform such that it no longer extends axially along a straight line, that distorted cartridge can “rock” within the cutter body pocket (e.g., radially pivot about the fastener) and potentially cause undesirable chatter. The axially extending support rib 78 is configured to provide the cartridge 24 with a significantly higher axial rigidity that inhibits or prevents the cartridge 24 from axially deforming under heavy operational loadings. In fact, a cartridge 24 embodiment like that shown in FIGS. 8-10 with an axially extending support rib 78 can increase the operational envelope within which the tool 10 can be used without detriment; e.g., such a cartridge 24 may be used for “roughing” operations. The increased width of the support rib 78 adjacent the cutting head portion 50 also increases the ability of the cartridge 24 to withstand any plastic deformation that may occur if the cartridge 24 is rotationally torqued or “twisted” within the pocket 22. Hence, a cartridge 24 that includes an axially extending support rib 78 as described herein may be used for applications not practically possible for a cartridge 24 without such an axially extending support rib 78.

Each cartridge 24 includes a cutting head 50 that may include a cutting chip control portion 52 and a cutting insert pocket 54. The cutting chip control portion 52 has a generally arcuate shape to direct abrasive cutting chips away from the cutter body 12 during use of the rotary cutting tool 10. As such, the cutting chip control portion 52 of the cutting head 50 decreases the potential for wear and damage to the cutter body 12. The present disclosure is not limited to cartridges 24 that include a cutting chip control portion 52.

The cutting insert pocket 54 of the cutting head 50 may be configured to receive and position a cutting insert 56. In some embodiments, the cutting insert pocket 54 may be configured to permit mounting of a plurality of different cutting insert 56 configurations; e.g., a “universal” pocket that can be used to mount a plurality of different cutting insert configurations. In some embodiments, the cutting insert pocket 54 and the cutting insert 56 may have complimentary geometries; e.g., at least part of the pocket 54 and at least part of the insert 56 have mating features that permit the insert 56 to be received and positioned by the cutting insert pocket 54. The cutting insert 56 may be secured to the cutting head 50 by brazing, mechanical fastener, or the like.

The present disclosure is not limited to any particular type of cutting insert 56 geometry or material. For example, in some embodiments a cutting insert 56 may be formed of a polycrystalline diamond (PCD) material, or a carbide material (e.g., tungsten carbide), or a polycrystalline cubic boron nitride material, or the like, or any of these materials backed with a different material (e.g., a carbide material). The present disclosure is not limited to any type of cutting insert material.

During set up of a present disclosure rotary cutting tool 10, each cartridge 24 is received within a pocket 22 and attached to the cutter body 12 by a fastener 28. The fastener 28 extends through the cartridge fastener aperture 44 and is threadably engaged with the threaded cartridge aperture 30 of the cutter body 12. The axis 58 of the fastener 28 securing the cartridge 24 within a pocket 22 of the cutter body 12 is disposed at an orientation that is non-perpendicular to the rotational axis 20 of the rotary cutting tool 10; e.g., disposed at angle “β”. Hence, the fastener 28, the fastener aperture 44, and the cartridge threaded aperture 30 extend along axes 58, 46, 32 (parallel or coincident) disposed at the acute angle “β” and are therefore disposed at an orientation that is non-perpendicular to the rotational axis 20 of the rotary cutting tool 10. When secured, the fastener 28 applies a fastener force “F_{F}” along the fastener axis 58. Because the fastener axis 58 is skewed by the angle “β” from a perpendicular line (i.e., a radial line), the fastener force “F_{F}” may be described as having a radial component “F_{R}” and an axial component “F_{A}”, as shown in the force vector diagram shown in FIG. 7. This is in contrast to existing cartridges attached to the cutting body of a rotary cutting tool by a clamping screw that extends perpendicular to the rotational axis of the rotary cutting tool; e.g., the clamping screw only produces a radial force component on the cartridge, and no axial force component. For those prior art cartridges held by a clamping screw that extends perpendicular to the rotational axis of the rotary cutting tool the cartridge position is maintained by friction between the cartridge and the cartridge pocket. In many instances, the prior art cartridge has a cartridge fastener aperture that is larger than the outer diameter of the cartridge fastener (e.g., to permit cartridge axial position adjustment). Forces applied to the prior art cartridge during cutting operations can, over time, overcome the frictional forces thereby causing the cartridge to axially displace. A displaced cartridge (even relatively small displacements) can negatively affect the cutting process, and will likely require the rotary cutting tool to be recalibrated—a costly and time intensive process. The present disclosure rotary cutting tool addresses this issue. As stated above, the engagement nut 64 is in contact with the aft end 76 of the respective cartridge 24. The axial force F_{A} component provided by the fastener 28 causes the cartridge 24 to be positively engaged with the engagement nut 64 and axial movement of the cartridge 24 is resisted not only by the frictional forces associated with the radial force FR component, but also by the axial force F_{A} component. As a result, in the present disclosure rotary cutting tool the cartridge 24 is held more securely within the pocket 22 and is less prone to movement (e.g., chatter) in all operational modes of the rotary cutting tool 10.

An example of a set up procedure that may be used with the present disclosure rotary cutting tool 10 includes placing the cartridges 24 in their respective cartridge pockets 22 around the circumference of the cutter body 12 and lightly tensioning the cartridge fasteners 28. The axial position of each cartridge 24 may be adjusted via its respective cartridge axial adjustment mechanism 60 to align all of the cartridges 24 and thereby establish uniform cartridge 24/cutting insert 56 positioning. Once the cartridges 24 are aligned, the cartridge fasteners 28 can be further tightened from the initial light tensioning position to an appropriate final, greater operating tension (i.e., fastener force—“F_{F}”) that includes a radial component (“F_{R}”) that frictionally secures the cartridge 24 within the pocket 22 and an axial component (“F_{A}”) that biases the cartridge 24 against the cartridge axial adjustment mechanism 60 (e.g., against engagement nut 64). It is our experience that the combined axial biasing and the radial forces provide a significant improvement in maintaining the cartridge 24 position for longer periods of operational time. In other words, the skewed fastener retention configuration of the present disclosure maintains the cartridges 24 in the desired position longer, thereby providing the rotary cutting tool 10 greater operational life for a given set of cartridges 24 without the need for recalibration/adjustment. Given the labor costs to set up a machine tool, the present disclosure provides the tool operator with a significant improvement.

From the foregoing description, one ordinarily skilled in the art can easily ascertain the essential characteristics of this invention and, without departing from the spirit and scope thereof, can make various changes and modifications to the invention to adapt it to various usages and conditions.

While the principles of the disclosure have been described above in connection with specific apparatuses, it is to be clearly understood that this description is made only by way of example and not as limitation on the scope of the disclosure.

The singular forms “a,” “an,” and “the” refer to one or more than one, unless the context clearly dictates otherwise. For example, the term “comprising a specimen” includes single or plural specimens and is considered equivalent to the phrase “comprising at least one specimen.” The term “or” refers to a single element of stated alternative elements or a combination of two or more elements, unless the context clearly indicates otherwise. As used herein, “comprises” means “includes.” Thus, “comprising A or B,” means “including A or B, or A and B,” without excluding additional elements. Further, the term “coupled” does not exclude the presence of intermediate elements between the coupled items. Also, any reference to attached, fixed, connected or the like may include permanent, removable, temporary, partial, full and/or any other possible attachment option.

It is noted that various connections are set forth between elements in the present description and drawings (the contents of which are included in this disclosure by way of reference). It is noted that these connections are general and, unless specified otherwise, may be direct or indirect and that this specification is not intended to be limiting in this respect. A coupling between two or more entities may refer to a direct connection or an indirect connection. An indirect connection may incorporate one or more intervening entities or a space/gap between the entities that are being coupled to one another.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures—such as alternative materials, structures, configurations, methods, devices, and components, alternatives as to form, fit, and function, and so on—may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein. For example, in the exemplary embodiments described above within the Detailed Description portion of the present specification, elements are described as individual units and shown as independent of one another to facilitate the description. In alternative embodiments, such elements may be configured as combined elements.

Additionally, even though some features, concepts, or aspects of the disclosures may be described herein as being a preferred arrangement or method, such description is not intended to suggest that such feature is required or necessary unless expressly so stated. Still further, exemplary or representative values and ranges may be included to assist in understanding the present application, however, such values and ranges are not to be construed in a limiting sense and are intended to be critical values or ranges only if so expressly stated.

Moreover, while various aspects, features and concepts may be expressly identified herein as being inventive or forming part of a disclosure, such identification is not intended to be exclusive, but rather there may be inventive aspects, concepts, and features that are fully described herein without being expressly identified as such or as part of a specific disclosure, the disclosures instead being set forth in the appended claims. Descriptions of exemplary methods or processes are not limited to inclusion of all steps as being required in all cases, nor is the order that the steps are presented to be construed as required or necessary unless expressly so stated. The words used in the claims have their full ordinary meanings and are not limited in any way by the description of the embodiments in the specification.

What is claimed is:

1. A rotary cutting tool, comprising:
a cutter body having a rotational axis that extends axially between a shank end and a cutter end, a circumferential exterior surface, and a plurality of cartridge pockets disposed in the circumferential exterior surface, wherein at least one cartridge fastener threaded aperture is disposed in the cutter body in each cartridge pocket, the cartridge fastener threaded aperture extending along an axis disposed at an acute angle, the acute angle being an included angle between a radial line perpendicular to the rotational axis and the rotational axis of the cartridge fastener threaded aperture;
a plurality of cartridges, each respective cartridge having a body configured to be received within a cartridge pocket, the body having at least one cartridge fastener aperture having an axis disposed at the acute angle;
a plurality of fasteners, each extending through the cartridge fastener aperture of a respective cartridge, and in threaded engagement with a one of the cartridge fastener threaded apertures disposed in the cutter body; and
a plurality of cartridge axial adjustment mechanisms, each cartridge axial adjustment mechanism aligned with a respective one of the plurality of cartridges;
wherein each fastener holds a respective one of the cartridges against a respective one of the cartridge pockets, and biases the respective one of the cartridges against a respective one of the cartridge axial adjustment mechanisms.

2. The rotary cutting tool of claim 1, wherein the acute angle is in the range of five to forty-five degrees.

3. The rotary cutting tool of claim 2, wherein the acute angle is about ten degrees.

4. The rotary cutting tool of claim 1, wherein each cartridge axial adjustment mechanism includes a set screw and an engagement nut, wherein each said fastener biases a respective one of the cartridges against the engagement nut of the respective one of the cartridge axial adjustment mechanisms.

5. The rotary cutting tool of claim 4, wherein the cartridge pockets extend between the cutter end of the cutter body and an annular channel, and the cutter body includes a plurality of set screw threaded apertures configured for threaded engagement with the set screws, the threaded apertures open to the annular channel;
wherein the engagement nuts are disposed in the annular channel and each said set screw is in threaded engagement with a one of the set screw threaded apertures.

6. The rotary cutting tool of claim 5, wherein the cartridge pockets and the cartridges have mating geometries.

7. The rotary cutting tool of claim 6, wherein each cartridge pocket has converging side walls configured in a V-shape, and each cartridge has a V-shaped body geometry that mates with the cartridge pocket.

8. The rotary cutting tool of claim 1, wherein each cartridge includes a cutting insert attached to the respective cartridge body.

9. A rotary cutting tool cartridge, comprising:
a body that extends axially between a forward end and an aft end, and has a front side and a back side, the back side is defined by a first back surface and a second back surface that extend axially between the forward end and the aft end, and converge toward one another and intersect a back edge;
the body including at least one fastener aperture that extends through the body from the front side to the back side along an fastener aperture axis that is disposed at an acute angle, wherein the acute angle is an included angle disposed between the fastener aperture axis and a line extending perpendicular to an axial line of the cartridge; and
the body including a cutting head portion disposed adjacent the forward end.

10. The rotary cutting tool cartridge of claim 9, wherein the acute angle is in the range of five to forty-five degrees.

11. The rotary cutting tool cartridge of claim 10, wherein the acute angle is about ten degrees.

12. The rotary cutting tool cartridge of claim 9, wherein the back edge is parallel to the line extending perpendicular to the axial line of the cartridge.

13. The rotary cutting tool cartridge of claim 9, wherein at the back edge the fastener aperture axis is disposed a first distance from the aft end of the body, and at the front side of the body the fastener aperture axis is disposed a second distance from the aft end of the body, and the second distance is greater than the first distance.

14. The rotary cutting tool cartridge of claim 9, wherein the fastener aperture is elongated in the axial direction.

15. The rotary cutting tool cartridge of claim 9, further comprising a cutting insert attached to the body.

16. The rotary cutting tool cartridge of claim 9, wherein the body includes a fastener engagement surface disposed on the front side, the fastener engagement surface extending radially out from the fastener aperture in a plane perpendicular to the fastener aperture axis.

17. The rotary cutting tool cartridge of claim 16, further comprising a support rib disposed on the front side, the support rib extending from the cutting head portion to the aft end of the cartridge.

18. The rotary cutting tool cartridge of claim 17, wherein a portion of the support rib surrounds at least a portion of the fastener engagement surface.

19. The rotary cutting tool cartridge of claim 9, further comprising a support rib disposed on the front side, the support rib extending from the cutting head portion to the aft end of the cartridge.

20. The rotary cutting tool cartridge of claim 19, wherein the support rib has a first width adjacent the aft end and a second width adjacent the cutting head portion, wherein the second width is greater than the first width.
